(19) United States
(12) Patent Application Publication
(10) Pub. No.: US 2019/0087825 A1
(43) Pub. Date: Mar. 21, 2019

(54) SYSTEMS AND METHODS FOR PROVISIONING BIOMETRIC TEMPLATES TO BIOMETRIC DEVICES

(71) Applicant: MASTERCARD INTERNATIONAL INCORPORATED, Purchase, NY (US)

(72) Inventors: Sumeet Bhatt, Jericho, NY (US); Ashfaq Kamal, Stamford, CT (US); Rajat Maheshwari, Singapore (SG)

(21) Appl. No.: 16/134,371

(22) Filed: Sep. 18, 2018

Related U.S. Application Data
(60) Provisional application No. 62/560,022, filed on Sep. 18, 2017.
(60) Provisional application No. 62/560,028, filed on Sep. 18, 2017.

(51) Int. Cl. G06Q 20/40; H04L 29/06; G06Q 20/20; G06Q 20/34

(52) U.S. Cl. CPC G06Q 20/40145; H04L 63/0861; G06Q 20/341; G06Q 20/202; G06Q 20/204; H04L 63/0853

(57) ABSTRACT

Systems and methods are provided for use in provisioning a biometric template to a biometric device. One exemplary method includes interacting, at a terminal associated with a banking institution, with a biometric device associated with a user and capturing a biometric of the user. The method also includes transmitting, by the terminal, an image of the captured biometric to a repository including a data structure of multiple biometric references, thereby permitting the repository to confirm the captured biometric against one of the multiple biometric references associated with the user. The method further includes receiving, at the terminal, a confirmation of the captured biometric matching the one of the multiple biometric references, converting the captured biometric to a biometric template upon such confirmation, and provisioning the biometric template to the biometric device, thereby permitting the user to be authenticated in connection with a transaction using the biometric device.

### CROSS-REFERENCE TO RELATED APPLICATIONS

This application claims the benefit of, and priority to, U.S. Provisional Application No. 62/560,022, filed on Sep. 18, 2017, and U.S. Provisional Application No. 62/560,028, filed on Sep. 18, 2017. The entire disclosures of the above-referenced applications are incorporated herein by reference.

### FIELD

The present disclosure generally relates to systems and methods for provisioning biometric templates to biometric card devices and, in particular, to systems and methods for use in provisioning biometric templates to biometric card devices where the biometric templates are based on biometrics captured and compared to data associated with biometric repository data structures.

### BACKGROUND

This section provides background information related to the present disclosure which is not necessarily prior art.

People are known to use payment accounts to purchase products and/or services, etc. The payment accounts are often associated with payment devices, such as credit or debit cards that typically may only be used by people whose names are embossed on front portions of the cards. Other payment devices are also likewise limited to use by only certain people, generally referred to as authorized users for the payment devices and/or corresponding payment accounts. In connection with transactions for the purchase of products, people performing the transactions are often authenticated prior to processing of the transactions and/or the transactions proceeding for authorization, etc. Such authentication may be based on signatures from the people performing the transactions, physical identification (e.g., presentation of driver's licenses, etc.), personal identification numbers (PINs), biometrics, or other conventional techniques, etc.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in provisioning a biometric template to a biometric card device and/or confirming biometric authentication of users in connection with payment account transactions;

FIG. 2 is a block diagram of a computing device that may be used in the exemplary system of FIG. 1;

FIG. 3 includes a flow diagram of an exemplary method, which may be implemented in connection with the system of FIG. 1, for provisioning a biometric template to a biometric card device; and

FIG. 4 includes a flow diagram of an exemplary method, which may be implemented in connection with the system of FIG. 1, for confirming biometric authentication of a user in connection with a transaction by the user.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment accounts may be used to purchase various different products and/or services, etc. The payment accounts may include credit, debit, prepaid or other accounts, where users associated with the accounts are provided payment devices, such as, for example, card devices, etc. The card devices may then be presented, by the users, to point-of-sale (POS) terminals, etc. to facilitate the purchase of desired products and/or services. In connection therewith, the users are authenticated, for example, through biometrics of the users (e.g., fingerprints, etc.). Biometric card devices often include fingerprint readers in the card devices, whereby biometric authentication of the users associated with the card devices may be completed on the card devices with results of such authentication passed to the POS terminals, for example. With that said, occasionally, it is unclear to issuers of the payment accounts whether such biometric authentication was actually performed for the payment account transactions and/or, when performed, if such biometric authentication was successful (at least for certain types of payment devices (e.g., payment cards, etc.)).

Uniquely, in connection with biometric authentication of a user as part of a requested purchase transaction by the user, the systems and methods herein provide a new provisioning sequence, whereby a biometric of the user, captured at a biometric reader of the user's corresponding card device, is verified against a repository data structure and then converted to a biometric template and stored in the card device. In particular, when the user is provided the biometric card device (by an issuer of a payment account, for example), the card device may initially be devoid of any biometric reference associated with the user. As such, at the time of issuance from the issuer, or later, the user presents the card device to an institution (e.g., a banking institution, etc.), which, in turn, captures an initial biometric from the user, for example, via a biometric reader external to the card device. The captured biometric and an identification number associated with the user are transmitted, by the institution, to a repository of biometrics, where a reference biometric is then identified, based on the user's identification number, and compared to the captured biometric. When a match is confirmed, the institution converts the captured biometric to a biometric template and provisions the biometric template to the user's biometric card device. In this manner, the biometric template is provisioned to the card device by the institution, only after the user's biometric is authenticated against the repository of reference biometrics.

What's more, the systems and methods herein provide for confirming biometric authentication of a user in connection with a payment account transaction by the user. In particular, when a payment account transaction is initiated at a merchant, the merchant (and specifically a POS terminal, or the like, associated with the merchant) compiles and transmits an authorization message for the transaction to a banking institution (associated with a payment account used in the transaction) and/or to a payment network (associated with processing the payment account transaction) for approval. Prior to compiling the authorization message, the merchant and/or the POS terminal may authenticate the user by comparing a biometric of the user captured at the POS terminal and/or by a card device presented by the user (e.g., a biometric card device, etc.) (broadly, a payment device) to a reference biometric for the user (e.g., retrieved from a central repository, retrieved from the payment device, etc.). After the user is authenticated, the POS terminal includes an identification number for the user (e.g., a government ID number, or part thereof; etc.) (received from the card device) in the authorization message, thereby indicating, in the authorization message, that the user has been biometrically authenticated in connection with the transaction. When the authorization message arrives at the banking institution (e.g., the issuer of the payment account, etc.), the banking institution may rely on the identification number, or part thereof, in the message (as an indicator of biometric authentication) in deciding whether to approve the transaction (e.g., in connection with one or more fraud algorithms, etc.) or not.

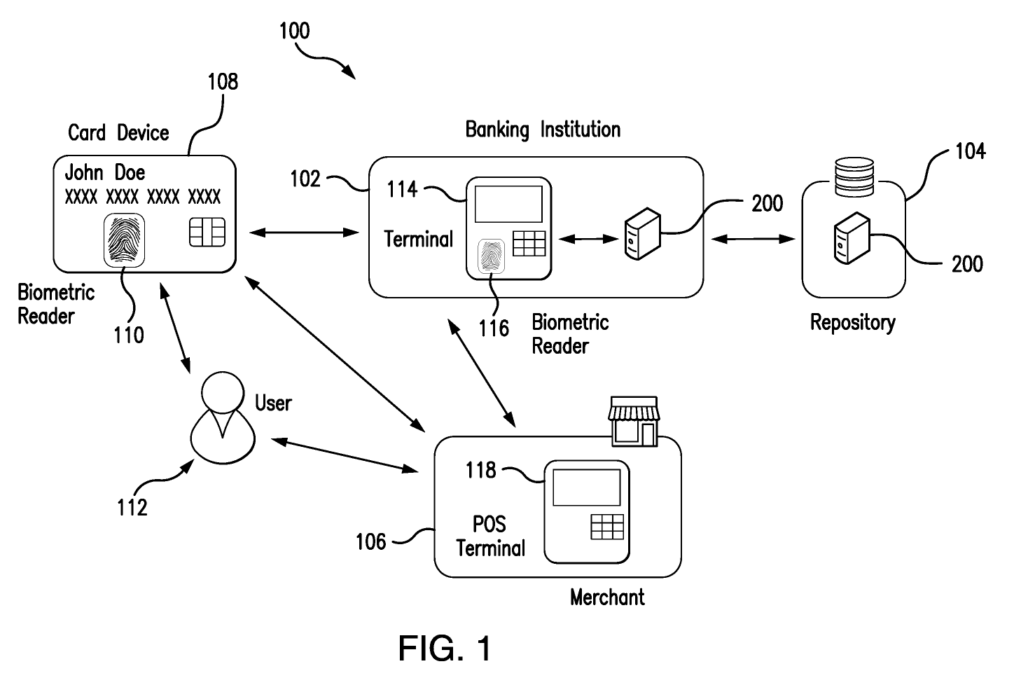

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, types of biometric devices used in the system 100, relationships among computing devices, configurations of banking institutions and/or biometric repositories used in the system 100, types of biometrics utilized to authenticate users, privacy requirements, etc.

The illustrated system 100 generally includes a banking institution 102, a repository 104, and a merchant 106, each of which is coupled to (and in communication with) one another via one or more networks. The network(s) are indicated generally by arrowed lines in FIG. 1, and each may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The banking institution 102 in the system 100 includes a financial institution such as a bank having one or more branches, which are physical locations into which a user is able to go to interact with the banking institution 102. Upon request, and approval (as is generally conventional), the banking institution 102 is authorized to issue one or more different types of accounts to the user, such as, for example, a checking account, a payment account (e.g., a debit account, a credit account, etc.), or other types of accounts, etc. The account(s) may then be used by the user to transfer funds, to fund transactions, or to otherwise manage funds, etc. While the banking institution 102 is specifically described as a bank in this example embodiment, other types of institutions in general, other than banks, may be included in other system embodiments (with the other institutions then configured to operate in similar manners to the description herein for the banking institution 102 in connection with authentication of users, etc.). With that said, the other types of institutions may include any institution configured to authenticate users associated with products and/or services offered by the institution. In at least one example, the other type of institution may include a business, a merchant, a retailer, or a business (which is not a bank or banking institution) that offers products and services for sale to users.

In connection with its issued accounts, the banking institution 102 herein also provides card devices to the associated accountholders, or more generally, to the users to which the accounts are issued, where each of the card devices is associated with at least one account issued by the banking institution 102. An exemplary card device 108 (broadly, a biometric device) is illustrated in FIG. 1. As shown, the card device 108 is a biometric card device, in that the card device 108 includes a biometric reader 110 integrated therein. Here, the biometric reader 110 includes a fingerprint reader (as indicated by the fingerprint symbol included in the biometric reader 110). As such, when a user 112 (associated with the card device 108) places his/her finger on the fingerprint reader 110, the card device 108 is configured to capture the fingerprint (e.g., as an image, etc.) via the biometric reader 110. What's more, the card device 108 is provisioned with a biometric template, as described below, against which the captured biometric may be compared. While the biometric reader 110 is specifically a fingerprint reader in this embodiment, the biometric reader 110 may be configured to capture one or more different types of biometrics in other system embodiments (e.g., biometrics associated with a user's iris, retina, palm, face, voice, etc.).

In addition, while the card device 108 is illustrated as a card herein, there is no requirement that the device 108 take the form of a card in all embodiments. For example, the device 108 may include a smartphone, another mobile device, another communication device, or any other device similar thereto, or not, in any suitable form factor. And, further, in at least one embodiment, the fingerprint reader 110 may be omitted from the card device 108 (e.g., when included at a point of sale (POS) terminal or other terminal, etc.)

The banking institution 102 also includes a terminal 114, such as, for example, a POS terminal, a kiosk, a smartcard reader, a mobile device, a tablet, a customer-interactive terminal, a teller terminal, etc. The terminal 114 includes a biometric reader 116, separate from the biometric reader 110 of the card device 108 and, thus, which is a biometric reader external to the card device 108. The biometric reader 116, in this exemplary embodiment, like the biometric reader 110, is a fingerprint reader configured to capture a fingerprint presented thereto. That said, the biometric reader 116 may be configured to read, scan or otherwise capture other types of biometrics in other embodiments (e.g., biometrics associated with a user's iris, retina, palm, face, voice, etc.).

The repository 104 in the system 100 is a repository data structure, in which biometric references for multiple users are stored (i.e., as a data structure of biometrics). The repository 104, in this exemplary embodiment, is associated with one or more government entities, services and/or programs, etc., whereby the repository 104 includes the biometric references for the multiple users (including the user 112), and where the biometric references are linked to identification numbers of the users (e.g., government-issued numbers (or government ID numbers) such as social security numbers, Aadhaar numbers, etc.). In one example, the repository 104 includes and/or is associated with the Unique Identification Authority of India (UIDAI) database, etc. It should be understood that the repository 104 may include more or less data related to the users, whereby the biometric references may be linked to other data related to the users (e.g., names, addresses, phone numbers, etc.), or not. In addition, the repository 104 may be associated with the banking institution 102 or some other institution(s) in other system embodiments, whereby the biometric references are linked to the identification numbers (e.g., government ID numbers, or otherwise), and/or other data related to the users.

With continued reference to FIG. 1, prior to using the biometric reader 110 at the card device 108 in connection with a transaction or other use of the card device 108, the banking institution 102 and/or the user is/are required to provision a biometric template to the card device 108, whereby the user 112 may be authenticated at the card device 108.

In particular, in connection with initially configuring the user's card device 108, the user 112 interacts with the banking institution 102, for example, at one of the corresponding branches of the banking institution 102, thereby permitting the user 112 to interact with the terminal 114. When the user 112 swipes, dips, taps or otherwise presents the card device 108 to the terminal 114 at the banking institution 102, the terminal 114 is configured to determine if a biometric template is stored in the card device 108 (e.g., in memory 204 of the card device 108, etc.), or not. When no biometric template is stored (or, for example, in response to an instruction to the card device 108 to re-write or replace a biometric template stored in the card device 108 (e.g., from the banking institution 102, etc.)), the terminal 114 is configured to prompt the user 112 for a biometric, via the biometric reader 116. In response, the user 112 places his/her finger, in this embodiment, on the biometric reader 116. The biometric reader 116 is configured to then capture an image of the user's fingerprint.

The terminal 114, in turn, is configured to transmit the captured biometric (e.g., encrypted, or not, etc.) (and not a biometric template representative of the captured biometric (i.e., the raw biometric data captured by the terminal 114 (or the reader 110, if applicable) such as the actual biometric image, subject to encryption or other security measures)) to the repository 104. The captured biometric (e.g., the captured biometric image, etc.) is transmitted along with an identification number of the user 112. Upon receipt of the captured biometric, the repository 104 is configured to retrieve a biometric reference for the user 112 (as identified from the identification number) and to confirm the captured biometric, received from the banking institution 102, matches the biometric reference. When matched, or confirmed, the repository 104 is configured to transmit a confirmation of the match to the banking institution 102 (and, in particular, the terminal 114). The terminal 114, in turn, is configured to, upon confirmation from the repository 104, convert the captured biometric (from the card device 108) into a biometric template (via a suitable algorithm) and to provision the biometric template to the card device 108. The card device 108 is configured, then, to store the biometric template in memory thereof, for use in subsequent authentication of the user 112.

Separately in the system 100, the merchant 106 is configured to offer and to sell products (e.g., goods, services, etc.) to one or more consumers, including, for example, to the user 112. In addition, the merchant 106, as shown, includes a POS terminal 118, which is configured to interact with the card device 108 when presented by the user 112, when the user 112 desires to purchase one or more of the products from the merchant 106.

In connection therewith, the user 112 is associated with a payment account issued to the user 112 by the banking institution 102. The payment account is linked to the card device 108, such that presenting the card device 108 to the merchant 106 in connection with a purchase transaction for one or more products facilitates funding of the transaction through the user's payment account. In this exemplary embodiment, the card device 108 includes the biometric card device, which includes the biometric reader 110 (and, specifically in this example, the fingerprint reader) to facilitate authentication of the user 112 in connection with the transaction. As such, the card device 108 also includes a biometric template for the user 112 (stored therein as described above), which is used to authenticate the user 112, by comparing the biometric template to a biometric captured at the biometric reader 110 of the card device 108. While the card device 108 is illustrated as a biometric card device herein, and while the biometric reader 110 is described as a fingerprint reader, it should be appreciated that other payment devices may be used in other embodiments (e.g., payment devices in the form of communication devices, fobs, etc.) and/or that payment devices having other forms of biometric readers may be used (e.g., where the biometric readers are specific to biometrics other than fingerprints (such as retina scans, voice samples, palm prints, facial images, etc.), etc. That said, even when the biometric reader 110 is omitted from the card device 108, the card device 108 may still include a biometric template such that a biometric may be captured at the POS terminal 118, for example, and then compared to the biometric template (either at the card device 108 or at the POS terminal 118).

In the illustrated embodiment, the card device 108 further includes a government ID number (broadly, an identification number) stored in memory therein (e.g., in an EMV chip of the card device 108, etc.). Consistent with the above, the government ID number may include, without limitation, an Aadhaar number relevant to India, a social security number relevant to the United States, or other suitable number, which is issued, in whole or in part, by a government entity in one or more different countries, region, states, etc.

In an exemplary transaction, the user 112 seeks to purchase a product from the merchant 106 using the payment account linked to the card device 108, whereupon the user 112 inserts, taps, or otherwise manipulates the card device 108 to interact with the POS terminal 118, generally in part, leaving the biometric reader 110 therein exposed. The POS terminal 118, in turn, is configured to recognize the card device 108 as a biometric card device and to solicit (in this example) a fingerprint from the user 112 at the biometric reader 110 of the card device 108. In response, the user 112 applies a finger to the biometric reader 110. In this example, the card device 108 is configured to capture the biometric and to compare the captured biometric to the biometric template stored therein. When there is a match (within conventional threshold(s)) between the captured biometric and the biometric reference (or confirmation thereof) (i.e., upon biometric authentication of the user 112), the card device 108 is configured to transmit the government ID number to the POS terminal 118.

Alternatively, when the POS terminal 118 captures the biometric from the user 112 (e.g., where the card device 108 presented to the merchant 106 does not include the biometric reader 116, etc.), the POS terminal 118 may be configured to provide the captured biometric to the card device 108. Upon receipt, the card device 108 is configured to compare the captured biometric to the biometric template as described above, and to transmit the government ID number to the POS terminal 118 when the captured biometric and the biometric template match (within conventional threshold(s)).

Then in the system 100, in response to receiving the government ID number from the card device 108, thereby indicating a successful authentication of the user 112 and/or as an indicator of a result of the biometric authentication, the POS terminal 118 is configured to compile an authorization request (broadly, an authorization message) including the government ID number, or part thereof, and to transmit the authorization request to the banking institution 102, either directly or through one or more other banking institutions (e.g., an acquirer, etc.) and/or payment networks (not shown). Specifically, in compiling the authorization request, the POS terminal 118 is configured to append the government ID number for the user 112, or a part thereof, to the authorization request at a specific data element and/or sub-element, or at any vacant part of the request message. In addition, the POS terminal 118 is configured to append various details of the transaction to the authorization request, such as a primary account number (PAN) for the user's payment account, a merchant ID for the merchant 106, a merchant category code (MCC) for the merchant 106, temporal data for the transaction, etc. (as is generally conventional in generating the authorization request). And, in turn, the merchant 106 and/or the POS terminal 118 is configured to transmit the authorization request to the banking institution 102 (e.g., via an acquiring banking institution, payment network, etc.) for authorization of the transaction (e.g., to determine if the consumer's payment account is in good standing, if the transaction poses only an acceptable risk of fraud, and if there is/are sufficient credit/funds to complete the transaction; etc.).

Upon receipt of the authorization request, the banking institution 102 is configured to determine if the authorization request includes the government ID number, or part thereof, or even an indication thereof (instead of the number itself) (e.g., based on a format of the government ID number as included in the authorization request (e.g., a number of digits for the government ID number, etc.), based on a location of the government ID number in the authorization request (e.g., based on data being present at the specific data element and/or sub-element that includes the given value for the government ID number, etc.), etc.). When the government ID number, or part thereof, is included, the banking institution 102 is configured to rely on its inclusion to approve and/or decline the transaction. Specifically, when the government ID number is located in the request, the banking institution 102 is informed that biometric authentication of the user 112 was performed in connection with the transaction and was successful. When the government ID number is not located in the authorization request (e.g., when the specific data element and/or sub-element that should include the government ID number is blank or empty, etc.), the banking institution 102 is informed that either biometric authentication was not attempted (e.g., a different authentication (e.g., PIN authentication, etc.) may have been completed, etc.) or that the biometric authentication failed.

Finally, regardless of whether the transaction is approved or declined by the banking institution 102, the banking institution 102 is configured to provide an authorization reply (broadly, an authorization message) back to the merchant 106 in response to the authorization request. And, depending on the reply, the merchant 106 is then able to continue the transaction with the user 112, or to request alternate funding for the transaction, and/or to halt the transaction, etc.

It should be appreciated that, while only one banking institution 102, one repository 104 and only one merchant 106 are illustrated in FIG. 1, a different number of these parts (and their associated components) may be included in the system 100, or as a part of other system embodiments, consistent with the present disclosure. Likewise, other system embodiments will generally include more than one card device (e.g., like card device 108 or different therefrom) may be issued by the banking institution 102 or other institution to the user illustrated in FIG. 1 and/or one or more other users.

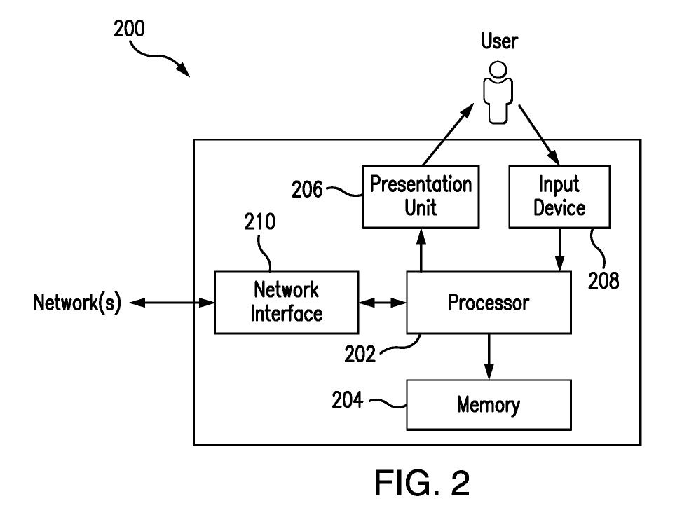

FIG. 2 illustrates an exemplary computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, and as described above, the banking institution 102 and the repository 104 are illustrated as including, or being implemented in, computing device 200, coupled to (and in communication with) one or more networks. In addition, the card device 108, the terminal 114, and the POS terminal 118 are each computing devices generally consistent with the computing device 200. However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an EMV chip, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, biometric templates, captured biometrics (e.g., fingerprints, facial images (e.g., selfies, etc.), etc.), biometric references, identification numbers (e.g., government ID numbers, etc.), and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the operations or processes described herein.

In the exemplary embodiment, the computing device 200 also includes a presentation unit 206 that is coupled to (and in communication with) the processor 202 (however, it should be appreciated that the computing device 200 could include output devices other than the presentation unit 206, etc.). The presentation unit 206 outputs information (e.g., results of biometric authentication, etc.), visually or audibly, for example, to a user of the computing device 200, etc. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

In addition, the computing device 200 includes an input device 208 that receives inputs from the user, such as, for example, biometrics for the user, etc., in response to prompts from a POS terminal, the card device 108, etc., as further described below. The input device 208 may include a single input device or multiple input devices. The input device 208 is coupled to (and is in communication with) the processor 202 and may include, for example, one or more of a keyboard, biometric reader (integrated or external) (e.g., biometric reader 110, biometric reader 116, etc.), a pointing device, a mouse, a camera, a touch sensitive panel (e.g., a touch pad or a touch screen, etc.), another computing device, and/or an audio input device. In various exemplary embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth™ adapter, etc.), a mobile network adapter, or other device capable of communicating to one or more different ones of the networks herein and/or with other devices described herein. Further, in some exemplary embodiments, the computing device 200 may include the processor 202 and one or more network interfaces incorporated into or with the processor 202.

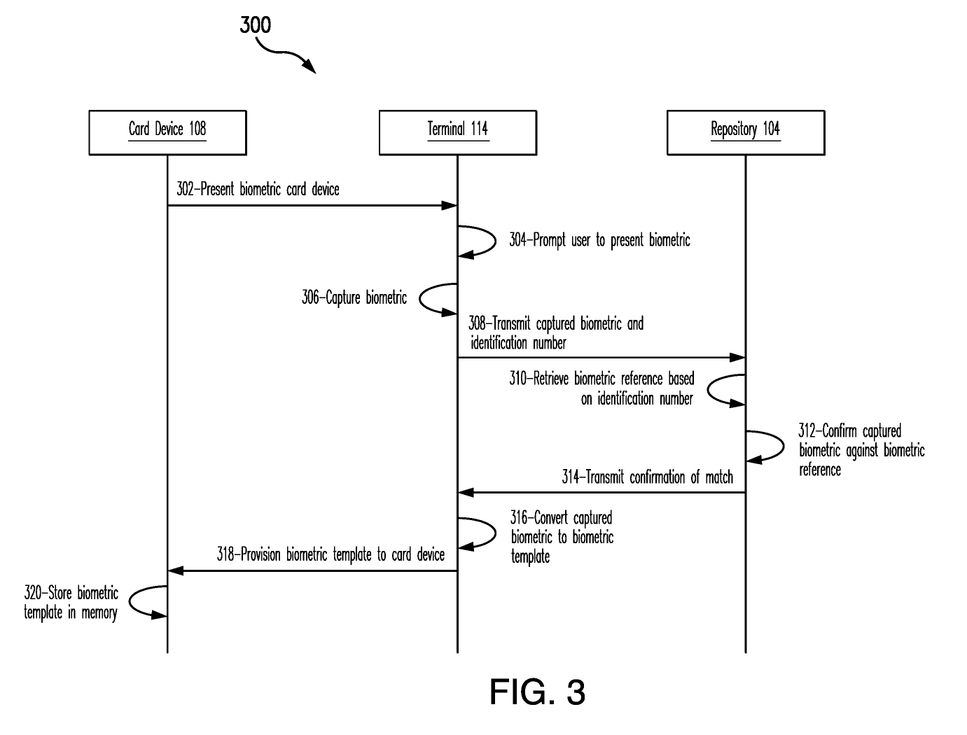

FIG. 3 illustrates an exemplary method 300 for use in provisioning a biometric template for the user 112 to the card device 108, for example, after the terminal 114 at the banking institution 102 captures the initial biometric from the user 112 (as just described). The exemplary method 300 is described, generally, as implemented in the repository 104, the biometric device 108, and the terminal 114 of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

In the method 300, and as described above in the system 100, the card device 108 is a device that is to be issued to and/or has previously been issued to the user 112, by the banking institution 102, and is associated with a payment account. As such, at this point in the method 300, the card device 108 is without a biometric template. Alternatively, at this point in the method 300, the card device 108 may include a biometric template, which is obsolete or otherwise not associated with the user 112 of the card device 108 (e.g., a biometric template of a prior user is included, etc.), whereby it should be replaced or overwritten. In any event, a biometric template is desired to be added to the card device 108 by the user 112 and/or the banking institution 102.

In connection therewith, the card device 108 is presented to the terminal 114 at the banking institution 102, at 302, to interact therewith. In doing so, the card device 108 is tapped, brought close to, inserted into (partially, or completely), dipped, or otherwise made to interact with the terminal 114. The terminal 114, in turn, may detect the card device 108 as being a biometric card and also a status of the card device 108 as being devoid of a biometric template. The terminal 114 may respond to the status, or may respond to a user input (at the terminal 114) to begin to provision a biometric template to the card device 108.

To do so, the terminal 114 prompts, at 304, the user 112 to present a biometric to the biometric reader 116 included and/or associated with the terminal 114 (e.g., an external fingerprint reader, etc.). For example, a prompt may be displayed at the presentation unit 206 of the terminal 114 (or audibly announced to the user 112, from the presentation unit 206 of the terminal 114). When the user 112 complies, the terminal 114 (and specifically, the biometric reader 116) captures, at 306, a biometric of the user 112. In this example, again, the biometric includes a fingerprint of the user 112, but may be otherwise in other method embodiments.

Upon capturing the biometric, optionally, the terminal 114 further solicits and/or retrieves (from memory 204) an identification number for the user 112, such as, for example, a payment account number, a government ID number, a customer ID, or other suitable identification number, etc. For example, the user may be invited to enter their social security number to an input device 208 of the terminal 114. In another example, the terminal 114 may retrieve the identification number from a memory associated with the terminal 114, wherein user information associated with the payment account linked to the card device 108 (as identified by the interaction between the card device 108 and the terminal 114) is retrieved therefrom. In still another example, the terminal 114 may retrieve the identification number directly from the card device 108.

In any case, the terminal 114 then transmits, at 308, the captured biometric and the identification number (and any other data captured from the user 112) to the repository 104 for verification (either directly or through one or more intermediaries (e.g., through a banking institution server, a third party, etc.). In so doing, the terminal 114 transmits raw biometric data (e.g., an image of the captured biometric, etc.) to the repository. In this manner, the terminal 114 attempts to verify the captured biometric in the repository 104. In turn, the repository 104 retrieves, at 310, a biometric reference for the user based on the identification number (and/or other data received from the terminal 114). Once retrieved, the repository 104 confirms, at 312, the captured biometric against the biometric reference, by comparing the captured biometric and the biometric reference to determine if a match exists (within conventional threshold(s)). When the captured biometric is confirmed, the repository 104 transmits, at 314, a confirmation of the captured biometric back to the terminal 114 (either directly or through the one or more intermediaries (e.g., the banking institution server, the third party, etc.)). For purposes of identification, the confirmation may include the captured biometric, the identification number, and/or some other indicia of the request for confirmation and/or the user.

Next, the terminal 114 converts, at 316, the captured biometric to a biometric template. The biometric template, in general, includes a numerical representation, or other representation, of the captured biometric different from the image of the captured biometric (e.g., based on one or more algorithms, etc.), which is suitable for use by the card device 108 in subsequently authenticating the user based on a further captured biometric at the biometric reader 110 at the card device 108 (e.g., as also converted to a numerical representation (or other corresponding representation) via the one or more algorithms, etc.). The biometric template is then provisioned, at 318, from the terminal 114 to the card device 108. When the captured biometric is converted and/or provisioned to the biometric device 108, the terminal 114 deletes the captured biometric (e.g., from memory 204, etc.), thereby avoiding the user's biometric from being present and/or retained in the terminal 114. Thereafter, the terminal 114 may further provide a notification to the user 112, such as, for example, “Enrollment Successful.”

In response to receiving the biometric template from the terminal 114, the card device 108 securely stores the biometric template in memory (e.g., the memory 204, etc.) for use in authenticating the user in subsequent transactions, at 320. That is, the card device 108 is now enabled to make transactions, whereupon a biometric authentication of the user 112 is required and/or permitted in order to proceed in authorizing the transactions.

It should be understood, conversely in the method 300, that when the initially captured biometric (as captured at the banking institution 102) is not confirmed by the repository 104, a confirmation of the failed match is transmitted back the terminal 114 (either directly or through one or more of the intermediaries (e.g., the banking institution server, the third party, etc.). This serves to then suspend and/or terminate the method 300. In such an instance, the terminal 114 may provide a notification to the user 112 that the provisioning and/or the biometric confirmation has failed (e.g., “Enrollment was unsuccessful due to Biometric mismatch,” etc.).

It should be appreciated that in one or more embodiments, the biometric for comparison to the biometric reference in the repository 104 may alternatively be captured at the biometric reader 110 of the card device 108 (as compared to the biometric reader 116 of the terminal 114), while the user 112 is at the banking institution 102. Here, the captured biometric would then be transmitted to the terminal 114, by the card device 108, in advance of the terminal 114 transmitting the captured biometric, at 306, to the repository 104. In addition, in at least one of these embodiments, upon confirmation from the repository 104 (via the terminal 114) that the captured biometric matches a reference biometric in the repository 104, the card device 108 may directly convert the captured biometric to the biometric template and then provision the biometric template to memory included therein.

That said, once the user's biometric template (e.g., for a fingerprint, etc.) is stored on the card device 108 and a “Chain of Trust” is created, at least part of the user's identification number (e.g., an Aadhaar number, etc.) can also be stored in the card device 108 at the same time (e.g., during the enrollment/configuration process, etc.) and the card device 108 is then issued and/or returned to the user 112. The user 112 is then able to use the card device 108 to perform desired transactions at merchants (e.g., via POS terminals at the merchants, etc.). And, when the user 112 presents a fingerprint to the biometric reader 110 of the card device 108 at the merchant 106, the card device 108 captures and matches the fingerprint image to the biometric template stored at the card device 108. When there is a match, the transaction is permitted, potentially, with or without the identification number associated with the user 112 (or part thereof) being included in the messaging for the transaction, thereby notifying the banking institution 102 that the user 112 was biometrically authenticated to initiate the transaction, as explained below. In the absence of the identification number (or part thereof) in the authorization messaging, the banking institution 102 and/or the terminal 114 (and/or the merchant 106), for example, may further require a PIN or other authentication for the user for the transaction to proceed.

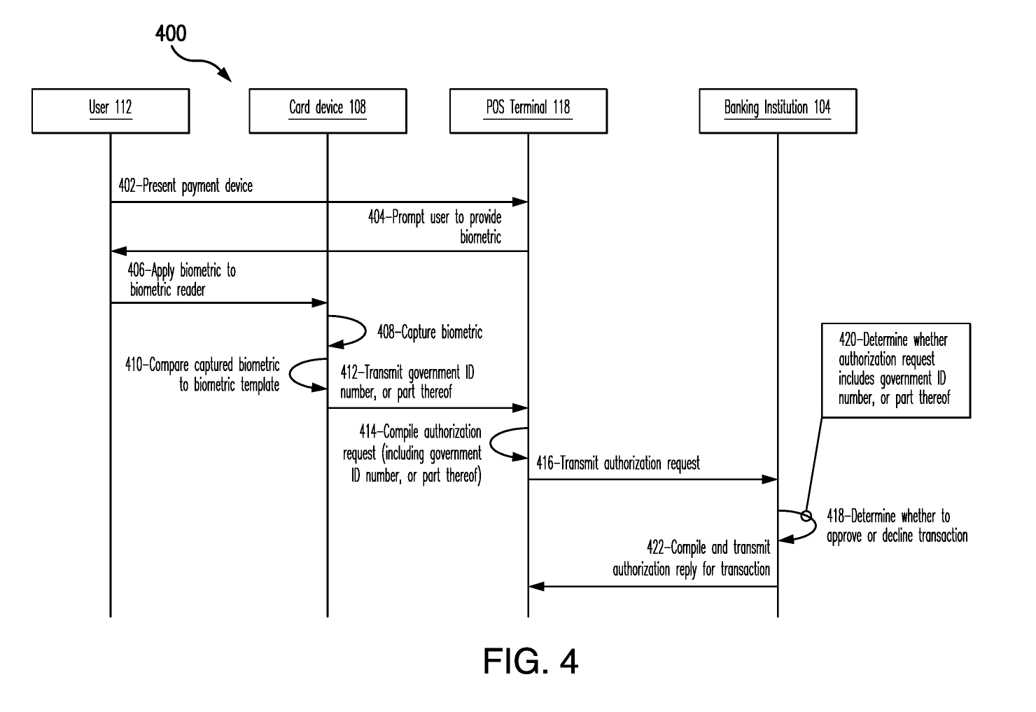

FIG. 4 illustrates an exemplary method 400 for use in confirming biometric authentication and, in particular, confirming biometric authentication of a user at a merchant, in connection with a transaction by the user, based on government ID numbers being included in network messages for the transactions. With that said, the exemplary method 400 is described (without limitation) as implemented, generally, in the POS terminal 118 of the merchant 106 and in the card device 108 of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 400.

At 402 in the method 400, the user 112 presents the card device 108 to the POS terminal 118 at the merchant 106, in connection with an attempt to initiate a payment account transaction with the merchant 106 to purchase one or more products. The card device 108 may be presented by inserting it into the POS terminal 118, in whole or in part (e.g., such that a EMV chip of the card device 108 is coupled in communication with the POS terminal 118, etc.). In the illustrated embodiment, where the card device 108 includes the biometric reader 116, the card device 108 is often inserted only partly into the POS terminal 118, or potentially not at all (where the card device 108 instead communicates in a contactless manner and/or a wireless manner with the POS terminal 118), so that the biometric reader 116 remains accessible and/or exposed to the user 112.

Thereafter, the POS terminal 118 prompts, at 404, the user 112 to provide a biometric, such as, for example, a fingerprint, etc., to the biometric reader 110 in the card device 108. In response, the user 112 applies, at 406, a finger to the biometric reader 116, or otherwise presents the requested biometric to the biometric reader 116. In turn, the card device 108 captures, at 408, a fingerprint of the user 112 (from the finger presented to the biometric reader 116) and, at 410, compares the captured biometric (e.g., fingerprint) to the biometric template for the user 112 stored in memory (e.g., memory 204, etc.) in the card device 108 (e.g., after converting the captured biometric to a corresponding template for comparison to the stored biometric template, etc.).

In performing such comparison, if the captured biometric and the biometric template match (within conventional threshold(s)), the card device 108 accesses a government ID number, which is stored in the card device 108 (e.g., in the memory 204 (e.g., in an EMV chip in the card device 108, etc.), etc.), and provides, at 412, the government ID number of the user 112 to the POS terminal 118. Conversely, if the captured biometric and the biometric template do not match (within conventional threshold(s)), the card device 108 does not provide the government ID number to the POS terminal 118. In the later scenario, the POS terminal 118 may request alternate authentication of the user 112 (e.g., PIN based authentication, etc.), whereupon the government ID number, or part thereof, will not be provided from the card device 108 to the POS terminal 118 and/or included in the authorization request (while the PIN or other authentication data may be included, in order to allow the transaction to proceed).

Subsequently in the method 400, when the biometric authentication is completed and upon receipt of the government ID number (or part thereof), by the POS terminal 118, the POS terminal 118 compiles, at 414, an authorization request for the transaction. The authorization request, as compiled by the POS terminal 118, includes the government ID number for the user 112, in whole or in part, at a specific element or sub-element, or any vacant element or sub-element, in the authorization request. The authorization request also includes various details of the underlying transaction (e.g., transaction amount, transaction time/day, information relating to the merchant 106, etc.). The POS terminal 118 then transmits, at 416, the authorization request to the banking institution 102, either directly or through one or more banking institutions and/or payment networks, for review.

Upon receipt of the authorization request, the banking institution 102 determines, at 418, whether to approve or decline the transaction. In connection therewith, the banking institution 102 determines, at 420, whether the authorization request includes the government ID number (or part thereof) for the user 112. For example, the banking institution 102 may determine if a number is included at a specific data element or sub-element in the authorization request, which is reserved for the government ID number (or part thereof) as an indication of the biometric authentication of the user 112 (e.g., if a number is present, the banking institution 102 concludes that biometric authentication of the user 112 was performed and successful, etc.). In another example, the banking institution 102 may separately retrieve the government ID number for the user 112 from memory (e.g., the memory 204, etc.) and compare the retrieved government ID number to one or more numbers included in the authorization request (i.e., to determine if there is a match). In the later example, the banking institution 102 is not required to know where in the authorization request the government ID number (or part thereof) is included (rather, it simply determines if a matching number is present anywhere in the request). Regardless of the specific manner in which it is determined, when the banking institution 102 determines that the government ID number (or part thereof) is included in the authorization request, the banking institution 102 understands that the user 112 performed a successful biometric authentication at the POS terminal 118. This determination may then be relied upon by the banking institution 102 in determining to approve or decline the transaction.

Finally in the method 400, when the transaction is approved or declined, the banking institution 102 compiles and transmits, at 422, an authorization reply to the merchant 106, either directly or through one or more banking institutions and/or payment networks. In response, when the reply indicates an approval, the merchant 106 may continue toward completion of the transaction, or, when the reply includes a decline, the merchant 106 may request alternate funding for the transaction and/or halt the transaction, etc.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims below.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in provisioning a biometric template to a biometric device, the method comprising:
interacting, at a terminal associated with a banking institution, with a biometric device associated with a user;
capturing, at a biometric reader of the terminal, a biometric of the user, wherein the biometric reader of the terminal is external to the biometric device;
transmitting, by the terminal, an image of the captured biometric to a repository, the repository including a data structure of multiple biometric references, thereby permitting the repository to confirm the captured biometric against one of the multiple biometric references associated with the user;
receiving, at the terminal, a confirmation of the captured biometric matching the one of the multiple biometric references associated with the user from the repository;
converting, at the terminal, the captured biometric to a biometric template upon confirmation from the repository; and
provisioning, by the terminal, the biometric template to the biometric device, thereby permitting the user to be authenticated in connection with performing a transaction using the biometric device by presenting a biometric to the biometric device.

2. The computer-implemented method of claim 1, wherein the identification number includes a government-issued number.

3. The computer-implemented method of claim 1, wherein converting the captured biometric to a biometric template includes converting the captured biometric to a numerical representation of the captured biometric.

4. The computer-implemented method of claim 1, further comprising, after interacting with the biometric device, soliciting, by the terminal, a biometric from the user when a provisioned biometric template is absent from the biometric device.

5. The computer-implemented method of claim 1, further comprising retrieving, by the repository, a biometric reference for the user based on the identification number and comparing the captured biometric, received form the terminal, against the retrieved biometric reference.

6. The computer-implemented method of claim 5, further comprising transmitting, by the repository, the captured biometric matching the one of the multiple biometric references associated with the user to the terminal.

7. The computer-implemented method of claim 1, wherein the biometric device includes a biometric card device associated with a payment account issued by the banking institution.

8. A system for use in provisioning a biometric template to a biometric device, the system comprising:
a terminal associated with a banking institution, the terminal having a biometric reader and configured to:
capture, via the biometric reader, a biometric of a user associated with a biometric device and an account issued by the banking institution, the biometric device linked to the account;
transmit an image of the captured biometric and an identification number for the user to a repository for confirming the captured biometric against a biometric reference identified at the repository based on the identification number;
in response to a confirmation of the captured biometric from the repository, convert the captured biometric to a biometric template; and
provision the biometric template to the biometric device associated with the user, thereby permitting the user to be authenticated at the biometric device in connection with one or more transactions to be funded by the account linked to the biometric device.

9. The system of claim 8, further comprising the biometric device including a second biometric reader;
the biometric device configured to:
store the biometric template in memory of the biometric device upon receipt of the biometric template from the terminal;
capture a biometric from the user, at the second biometric reader; and
authenticate the user, based on the captured biometric at the second biometric reader and the stored biometric template, in connection with the one or more transactions.

10. The system of claim 9, wherein the biometric device includes a biometric card device.

11. The system of claim 8, wherein the terminal is further configured to determine whether a biometric template is provisioned to the biometric device prior to capturing the biometric from the user.

12. The system of claim 8, wherein the biometric template includes a numerical representation of the captured biometric, different from the image of the captured biometric.

13. A computer-implemented method for use in confirming biometric authentication of a user in connection with a transaction to a payment account issued to the user, the method comprising:
capturing, at a biometric reader of a card device, a biometric of a user, the card device issued to the user, associated with a payment account issued by a banking institution, and provisioned with a biometric template of the user;
comparing, by the card device, the captured biometric to the biometric template included in the payment device; and
in response to a match between the captured biometric and the biometric template, transmitting, by the card device, at least a portion of a government ID number associated with the user to a point-of-sale (POS) terminal in communication with the card device in connection with a transaction involving the payment account, thereby permitting the POS terminal to include the at least a portion of the government ID number in an authorization request for the transaction as an indicator of biometric authentication of the user in connection with the transaction.

14. The computer-implement method of claim 13, further comprising retrieving the at least a portion of the government ID number from an EMV chip in the card device, prior to transmitting the at least a portion of the government ID number to the POS terminal.

15. The computer-implement method of claim 13, wherein the biometric template includes a fingerprint template; and
wherein the at least a portion of the government ID number includes an Aadhaar number.

16. The computer-implemented method of claim 13, further comprising:
receiving, by the POS terminal, the at least a portion of the government ID number;
compiling, by the POS terminal, an authorization request for the transaction, the authorization request including the at least a portion of the government ID number; and
transmitting, by the POS terminal, the authorization request toward the banking institution associated with the payment account, thereby permitting the banking institution to understand the at least a portion of the government ID number in the authorization request as the indicator of biometric authentication of the user in connection with the transaction

17. The computer-implemented method of claim 13, further comprising at least partially inserting the card device in the POS terminal, prior to capturing the biometric of the user, so that the biometric reader of the card device is exposed to the user, while the card device is at least partially inserted in the POS terminal.

18. A computer-implemented method for use in confirming biometric authentication of a user in connection with a transaction, the method comprising:
in connection with a transaction, receiving, by a point-of-sale (POS) terminal of a merchant, at least a portion of a government ID number, associated with a user, from a payment device, based on a biometric authentication of the user at the payment device, the payment device associated with a payment account issued to the user and used to fund the transaction with the merchant, the government ID number being different than an account number indicative of the payment account;
compiling, by the POS terminal, an authorization request for the transaction, the authorization request including the at least a portion of the government ID number associated with the user and the account number indicative of the payment account; and
transmitting, by the POS terminal, the authorization request toward a banking institution associated with the payment account, whereby the banking institution is permitted to confirm biometric authentication of the user in connection with the transaction, based on the at least a portion of the government ID number being included in the authorization request.

19. The computer-implement method of claim 18, wherein the POS terminal includes a biometric reader; and
further comprising:
soliciting, by the POS terminal, the user to present the biometric to the biometric reader; and
transmitting the captured biometric to the card device, prior to receiving the at least a portion of the government ID number from the card device.

20. The computer-implement method of claim 18, wherein the at least a portion of the government ID number include the entire government ID number associated with the user.
